(19) United States
(12) Patent Application Publication
(10) Pub. No.: US 2016/0039184 A1
(43) Pub. Date: Feb. 11, 2016

(54) APPARATUS AND POLYPROPYLENE-BASED COMPOSITION FOR WRAPPING A PIPE WELD

(71) Applicant: SHAWCOR LTD., Toronto (CA)

(72) Inventor: Dilip Tailor, Mississauga (CA)

(21) Appl. No.: 14/780,142

(22) PCT Filed: Mar. 24, 2014
(86) PCT No.: PCT/CA2014/050303

§ 371 Date: Sep. 25, 2015

Related U.S. Application Data
(60) Provisional application No. 61/805,237, filed on Mar. 26, 2013.

(51) Int. Cl. B32B 27/08; B32B 27/34; B32B 27/32

(52) U.S. Cl. CPC B32B 27/08; B32B 27/32; B32B 27/34; B32B 2307/736; B32B 2307/54; B32B 2307/581; B32B 2307/558; B32B 2307/202; B32B 2307/21; B32B 2307/7242; B32B 2553/00

(57) ABSTRACT

Laminate covering, in particular tapes and/or wrap-around sheets applied via an auto-wrapping machine, used for the mechanical and corrosion protection of oil, gas and water transmission pipelines. The laminate covering comprises a cross-linked polyolefin outer layer and an inner layer, which may be an adhesive, and has improved mechanical properties when compared to the prior art. The laminate covering may be pre-stretched. Also, a method of applying said laminate covering. The laminate covering can be applied to a pipe in a lower cost, faster application.

### FIELD OF INVENTION

The present invention relates to coverings, and in particular to tapes and/or wrap-around sheets applied via an auto-wrapping machine, used for the mechanical and corrosion protection of oil, gas and water transmission pipelines.

The laminate covering comprises a cross-linked polyolefin outer layer and an adhesive inner layer, and has improved mechanical properties when compared to the prior art. It can also be applied to a pipe in a lower cost, faster application.

### BACKGROUND

Oil, gas and water transmission pipelines typically comprise a steel pipe that is covered in a polyolefin layer which provides corrosion, impact, penetration, and moisture protection. Typical installation of a pipeline comprises connecting a multiplicity of discrete pipe lengths together. Each pipe length is welded, in turn, to the end of the pipeline, increasing the length of the pipeline. Pipe lengths are typically already coated with polyolefin or other coatings when welded to the pipeline. However, pipe sections are manufactured such that the polyolefin coating does not extend to the end of the pipe section, resulting in exposed steel ends, which are used to weld the pipes together. Once a pipe section is welded to a pipeline, this results in a “cutback region”, surrounding the weld, which is exposed steel, and not coated. Typical pipeline construction requires the coating of these cutback regions, in the field, with a suitable coating, to protect the weld joint from corrosion, impact, penetration and moisture.

One way of coating the cutback region in the field is through the use of a tape or wrap-around sheet, applied via an auto-wrapping machine, as follows.

The weld joint is cleaned via blasting, heated to a temperature of 240° C.-250° C., and coated with fusion bonded epoxy. The auto-wrapping machine then winds a tape or sheet around the pipe weld joint as many times as is necessary to reach the desired thickness. During the winding process, tension is applied to the tape and rollers are used to ensure the covering conforms to the pipe weld. The tension, and heat, fuses the tape or sheet to itself, forming an essentially uniform coating.

Auto-wrapping machines are known in the art; examples include the PP/PE Automated Tape Wrap machine (Pipeline Induction Heat Ltd., Burnley, UK) and OJS PolyFuse Equipment (Offshore Joint Services Inc., Texas, USA). Also see the auto wrapping machine described in US patent application 2007/0227647 A1, also to Pipeline Induction Heat, Ltd., and in U.S. Pat. No. 4,134,782, U.S. Pat. No. 4,409,088, U.S. Pat. No. 4,426,834, U.S. Pat. No. 4,008,114, U.S. Pat. No. 5,954,918, and U.S. Pat. No. 7,243,697, all incorporated herein by reference.

Tapes and sheets for use with auto-wrapping machines are known in the art, and are typically one layer of material, comprising a non-crosslinked, non-prestretched polyolefin, typically polypropylene or polyethylene, or compounds based on these polymers. For example, the PP/PE Automated Tape Wrap machine noted above spirally wraps non-prestretched, non-crosslinked, single layer polypropylene or polyethylene tape around the pipe weld joint. The tape is readily and commercially available, for example, from Pipeline Induction Heat, Ltd., and typically such tapes are 0.1-4 mm thick and between 4-16 inches wide. The OJS PolyFuse Equipment similarly applies a non-prestretched, non-crosslinked, polypropylene film around the pipe weld joint.

3M™ Scotchkote™ PNC 1011 tape is another option available for use with auto-wrapping machines. This tape comprises a single layer non-prestretched, interpenetrating polymer network of polyolefins and epoxy, which is prepared as described in U.S. Pat. No. 7,790,288 and U.S. Pat. No. 8,231,943. The manufacturing process is complex, and may result in a tape with a variable structure. In order to cover pipe weld joints with the currently known polypropylene tapes and sheets, the pipe temperature must be greater than 220° C. in order for the tape to bind to the epoxy coating. It is also necessary to apply considerable tension and pressure to the tape in order for it to conform to the pipe weld. As can be appreciated, if the temperature of the pipe, or the tension, and/or pressure exerted on the tape/sheet are too low, the tape/sheet does not properly adhere to the epoxy coated layer, and/or does not properly bond to itself. Conversely, if the temperature of the pipe is too high, or the tension and/or pressure exerted on the tape/sheet is too high, the tapes or sheet will melt or tear, either during application by the auto wrapping machine, or after application.

For effective application, it is important to control the melt index/viscosity and the hot strength of the tape or sheet in a very tight window.

The melt index/viscosity must be low enough so that the tape or sheet can flow into the joint crevices, and conform well to the weld bead and the step-down from the mainline coating to the steel.

With respect to hot strength, when the tape or sheet is wrapped around the pipe joint at temperatures exceeding the melting point of the tape or sheet polymer, two properties of the polymer related to hot strength become critical: tensile strength and compressive strength. When the tape or sheet is tensioned for conformance during wrapping, it must have sufficient tensile strength to sustain tension without breaking or tearing off. When the tape or sheet is compressed with a roller for adhesion and conformance, the tape or sheet should have sufficient compressive strength to withstand compression without deforming or puncturing. For example, plastic deformation results in loss of thickness and stress damage that affects the tape's long term aging performance. These hot strength property requirements frequently go against the need for low viscosity, and as the latter results necessarily in low hot strength.

A covering that is not properly applied is often not identified until many years layer, and may cause failure of the pipe through corrosion or other damage. A tape or sheet that melts or tears during application will result in considerable added time and expense for the construction of the pipeline.

Polypropylene has a melting point of 165° C. Therefore, preheating a pipe to greater than 165° C. would significantly soften a non-crosslinked tape or sheet, such as those known in the prior art. Additionally, external heat applied to the tape or sheet to allow it to stretch and conform would make it excessively pliable and susceptible to thinning out and tearing.

Shrink sleeves made of prestretched, crosslinked polyolefins are known in the art; one example is the shrink sleeve available from CANUSA-CPS (a division of ShawCor Ltd., Toronto, Calif.). These sleeves consist of polyolefins prestretched anywhere from 20-200% of its original, fully recovered length. For standard pipeline joints with mainline coating thicknesses of up to 6.0 mm, the prestretch is 25-50%, and typically 30%.

To apply a shrink sleeve to a pipe weld joint, the shrink sleeve is wrapped relatively loosely around the pipe weld joint. The sleeve is then shrunk by heating, starting at the middle and then out toward the edges to ensure there are no trapped air voids. About 10-20% of the sleeve stretch is used up just to make intimate contact with the substrate. The installed sleeve will then have about 10-20% residual stretch remaining, which is necessary to maintain the long term hoop stress in the sleeve in order to sustain the sealing capability of the sleeve.

When applying shrink sleeves on a pipe, it is desirable that the shrink sleeves are initially wrapped loosely around the pipe weld joint for two reasons. First, it is difficult to wrap them tightly due to the uneven profile of the pipe joint resulting from the presence of the girth weld and the transition step down from the mainline coating to the steel. Second, the loose wrapping allows the air under the sleeve to escape.

The shrink sleeves known in the art, however, generally are not ideal for use with auto-wrapping machines. When these sleeves are placed in contact with the heated pipe weld joint, they shrink rapidly, giving unpredictable results, making it likely that the leading edge of the sleeve will curl up and away from the pipe weld joint.

Closure technology for sheets are also known in the art, including a high temperature, high shear adhesive tape strip on an overlap end of the sheet, and a base overlap end fused to the underwrap by heat and pressure; see for example U.S. Pat. Nos. 4,472,468, 4,359,502, 5,175,032, and 5,411,777, incorporated herein by reference.

### SUMMARY OF INVENTION

According to one aspect of the present invention is provided a polymer-based laminated covering, in the form of a tape or sheet, comprising at least two layers: a first layer comprising a crosslinked polymeric material which forms an outer lamina of the covering, and a second layer comprising an adhesive or a non-crosslinked polyolefin or polyamide which forms an inner lamina of the covering. The covering is for use with an auto-wrapping machine, for application to a pipe joint in the field; the pipe joint comprising the exposed steel around the girth weld and the adjacent coating.

The use of a crosslinked polymeric material for the first layer renders the covering resistant to high temperature, and prevents melting or tearing during application, despite the tension and pressure that are applied by the auto-wrapping machine to ensure the covering conforms to the pipe weld.

In certain embodiments, the first layer is a prestretched crosslinked polymeric material. The use of a pre-stretched material results in a lower tension being required during application of the covering to the pipe, since the prestretched layer will shrink upon contact with the hot pipe, resulting in excellent conforming of the covering to the pipe joint.

In certain embodiments, the second layer results in the application process being cheaper and quicker as the pipe only needs to be preheated to 160° C.-200° C., rather than 220° C.-250° C. when polypropylene systems are used, and even lower, for example 90° C.-120° C., when ethylene, or 40-100° C. when amide based systems are used.

Thus, according to one aspect of the present invention is provided a laminated covering for use with an auto-wrapping machine comprising: a) a first layer comprising a crosslinked polymeric material which forms an outer lamina of the covering; and b) a second layer which forms an inner lamina of the covering.

In an embodiment of the invention, a leading edge of about 1-6 inches has a lower degree of crosslinking as compared with the rest of the laminated covering.

In a further embodiment of the invention, the first layer is a heat shrinkable layer.

In a further embodiment of the invention, the crosslinked polymeric material is prestretched by under 20% of its original, fully recovered length. In certain embodiments, the crosslinked polymeric material may be prestretched by 1 to 10% of its original, fully recovered length, for example, by 5%, or 3-5%, of its original, fully recovered length. In certain embodiments, the leading edge of about 1-6 inches is prestretched by up to or less than 2% of its original, fully recovered length.

In a further embodiment of the invention, the polymeric material is epoxy-free.

In a further embodiment of the invention, the laminated covering comprises an additional functional layer which forms an intermediate lamina of the covering, said functional layer having at least one property superior to said crosslinked polymeric material, said at least one property selected from a group consisting of: high temperature penetration resistance, softening point, impact resistance, long-term thermal stability, tensile strength, toughness, stiffness, thermal insulation, electrical conductivity or static dissipation, and impermeability to gases and moisture.

In a further embodiment of the invention, the crosslinked polymeric material is a crosslinked polyolefin material.

In a further embodiment of the invention, the functional layer comprises a crosslinked polymeric material. In a further embodiment of the invention, the functional layer comprises a non-crosslinked polymeric material.

In a further embodiment of the invention, the crosslinked polyolefin material and/or the functional layer comprises a propylene homopolymer or a copolymer of propylene and an olefin other than propylene. The copolymer of propylene may be a copolymer of propylene and ethylene. The propylene homopolymer or copolymer of propylene may further be modified with a functional group selected from a group consisting of: silanes, acrylic acids, alkyl acrylic acids, glycidyl acrylates, alkyl acrylates, anhydrides, vinyl acetates and combinations thereof.

In a further embodiment of the invention, the crosslinked polyolefin material and/or the functional layer comprises an ethylene homopolymer or an ethylene copolymer. The ethylene copolymer may further be modified with one or more reactive functional groups selected from a group consisting of: vinyl acetate, vinyl alcohol, alkyl acrylates, vinyl acetates, anhydrides, a higher olefin, and combinations thereof. The said higher olefin may be selected from a group consisting of butene, hexene, and octene. The ethylene homopolymer may be selected from a group consisting of: high density polyethylene, medium density polyethylene, linear medium density polyethylene, low density polyethylene, linear low density polyethylene, and combinations thereof.

In a further embodiment of the invention, the crosslinked polyolefin material and/or the functional layer comprises an elastomer selected from a group consisting of: ethylene-propylene diene elastomers, crystalline propylene-ethylene elastomers, and thermoplastic polyolefin elastomers.

In a further embodiment of the invention, the crosslinked polymeric material comprises a combination of two or more of: a propylene homopolymer, a copolymer of propylene and an olefin other than propylene, an ethylene homopolymer, an ethylene copolymer, and an elastomer. The copolymer of propylene may be a copolymer of propylene and ethylene. The propylene homopolymer or copolymer of propylene may be modified with a functional group selected from a group consisting of: silanes, acrylic acids, alkyl acrylic acids, vinyl acetates, glycidyl acrylates, alkyl acrylates, anhydrides and combinations thereof. The ethylene copolymer may be modified with one or more reactive functional groups selected from a group consisting of: vinyl acetate, vinyl alcohol, alkyl acrylates, and a higher olefin. The said higher olefin may be selected from a group consisting of: butene, hexene, and octene. The ethylene homopolymer may be selected from a group consisting of: high density polyethylene, medium density polyethylene, linear medium density polyethylene, low density polyethylene, linear low density polyethylene, and combinations thereof. The elastomer may be selected from a group consisting of: ethylene-propylene diene elastomers, crystalline propylene-ethylene elastomers, and thermoplastic polyolefin elastomers.

In a further embodiment of the invention, the functional layer comprises a compound selected from a group consisting of: a filled polyolefin, a polyolefin nanocomposite, an engineering thermoplastic, a barrier polymer, a thermally insulating polymer, and an electrically conductive polymer. The filler in the filled polyolefin may be selected from the group consisting of: clay, mica, talc, silica, wollastonite, wood, glass fibres, metal oxides, aerogels, and conductive fillers. The said conductive filler may be selected from a group consisting of: carbon black and metallic powder. The polyolefin nanocomposite comprises a polyolefin and an exfoliated clay additive. The engineering thermoplastic may be selected from the group consisting of: nylons, polyesters, and polyurethanes. The thermally insulating polymer may comprise a polyolefin and a low conductivity insulating filler selected from the group consisting of: hollow glass, ceramic, polymer microspheres, and aerogels. The electrically conductive polymer may comprise an intrinsically conductive polymer such as polyaniline and/or an electrically conductive filler comprising carbon black or a metal powder.

In a further embodiment of the invention, the crosslinked polymeric material further comprises at least one additive selected from a group consisting of: cross-linking promoters, compatibilisers, modifiers, pigments, antioxidant stabilizers, heat stabilizers, ultraviolet (UV) stabilizers, fillers, flame retardants, and process aids. The compatibiliser may be selected from a group consisting of: ethylene-propylene copolymers; ethylene-propylene diene elastomers; crystalline propylene-ethylene elastomers; thermoplastic polyolefin elastomers; metallocene polyolefins; copolymers of ethylene with vinyl acetate, vinyl alcohol, and/or alkyl acrylates; polybutenes; hydrogenated and non-hydrogenated polybutadienes; butyl rubber; polyolefins modified with reactive functional groups selected from the group comprising silanes, alcohols, amines, acrylic acids, methacrylic acids, acrylates, methacrylates, glycidyl methacrylates, and anhydrides; polyolefin ionomers; polyolefin nanocomposites; block copolymers selected from the group comprising styrene-butadiene, styrene-butadiene-styrene, styrene-ethylene/propylene and styrene-ethylene/butylene-styrene; and thermoplastic elastomers comprising polypropylene blended with an elastomer. The said thermoplastic elastomer may comprise polypropylene blended with ethylene propylene.

In a further embodiment of the invention, the second layer is an adhesive layer or a non-cross-linked tie-layer.

In a further embodiment of the invention, the second layer is an adhesive layer comprising a polypropylene, polyethylene or a polyamide; or copolymers of respective polymer type; or a respective polymer type that has been chemically modified with a reactive functional group such as silanes, alcohols, amines, acrylic acids, methacrylic acids, acrylates, methacrylates, glycidyl methacrylates, and anhydrides.

In a further embodiment of the invention, the second layer is an adhesive layer as described above, but mixed with other copolymers of ethylene vinyl acetates, ethylene ethyl acrylates, and/or hydrocarbon resins. These adhesives are well known in art and are described, for example, in U.S. Pat. No. 4,732,412, U.S. Pat. No. 4,181,775, U.S. Pat. No. 4,018,733 and U.S. Pat. No. 4,338,970, all of which are incorporated herein by reference.

In a further embodiment of the invention, the laminated covering is in the form of a tape. The tape may have a width between 2 to 24 inches and a thickness between 0.1 to 4 millimetres. More specifically, the tape may have a width between 4 to 16 inches and a thickness between 0.5 to 2 millimetres.

In a further embodiment of the invention, the laminated covering is in the form of a wrap-around sheet. The wrap-around sheet may have a width between 2 to 60 inches and a thickness between 0.1 to 6 millimetres. More specifically, the wrap-around sheet has a width between 6 to 36 inches and a thickness between 0.5 to 3 millimetres

In a further embodiment of the invention, the wrap-around sheet is of such a length that after being wound around an article the wrap-around sheet comprises an overlapping portion.

In a further embodiment of the invention, the wrap-around sheet further comprises a closure strip for fastening together the end portions of the wrap-around sheet, said closure strip comprising a high temperature, high shear adhesive tape, or an overlap end that is devoid of second layer.

The present invention provides a method for coating an elongate metallic tubular article, comprising: a) cleaning the elongate metallic tubular article; b) heating the elongate metallic tubular article; c) winding the tape at least one time around the elongate metallic tubular article in such a manner that the metallic tubular article is in contact with the second layer of the tape.

The present invention provides a method for coating an elongate metallic tubular article, comprising: a) cleaning the elongate metallic tubular article; b) heating the elongate metallic tubular article; c) applying an epoxy coating to the elongate metallic tubular article; d) heating the elongate metallic tubular article coated with epoxy to a higher temperature; and e) winding the tape at least one time around the elongate metallic tubular article in such a manner that the epoxy-coated elongate metallic tubular article is in contact with the second layer of the tape.

In an embodiment of the invention, step (b) comprises heating to 40 to 60° C. or to at least 10° C. above the dew point.

In a further embodiment of the invention, there is no additional heating step between steps (c) and (e).

In a further embodiment of the invention, the epoxy is a fusion bonded epoxy powder or a liquid epoxy. The typical liquid epoxy used in such corrosion protection application is described in the prior art, for example, in U.S. Pat. No. 4,732,632, incorporated herein by reference. The fusion bonded epoxy is described for example in U.S. Pat. No. 8,231,943 B2 and the US Pub. No.: 2007/0227647 A1, both incorporated herein by reference.

In a further embodiment of the invention, the higher temperature is 40° C. to 240° C. More specifically, the higher temperature may be 60° C. to 200° C. Even more specifically, the higher temperature may be 160° C. to 200° C.

In a further embodiment of the invention, the tape is wound spirally around the elongate metallic tubular article with an overlap equal to 5 to 55% of the width of the tape. More specifically, multiple layers of tape may be wound spirally around the elongate metallic tubular article to achieve the required thickness.

In a further embodiment of the invention, the tape is maintained under tension while it is being wound around the elongate metallic tubular article.

In a further embodiment of the invention, the tape is wound around the elongate metallic tubular article using an auto-wrapping machine. More specifically, the auto-wrapping machine may contain at least one roller that presses the tape against the elongate metallic tubular article while the tape is being wound around the elongate metallic tubular article.

The present invention provides a method for coating an elongate metallic tubular article, comprising: a) cleaning the elongate metallic tubular article; b) heating the elongate metallic tubular article; c) before the elongate metallic tubular articles has time to cool, winding the wrap-around sheet around the elongate metallic tubular article in such a manner that the elongate metallic tubular article is in contact with the second layer of the sheet.

The present invention provides a method for coating an elongate metallic tubular article, comprising: a) cleaning the elongate metallic tubular article; b) heating the elongate metallic tubular article; c) applying an epoxy coating to the elongate metallic tubular article; and d) heating the elongate metal tubular article coated with epoxy to a higher temperature; and (e) winding the wrap-around sheet around the elongate metallic tubular article in such a manner that the epoxy-coated elongate metallic tubular article is in contact with the second layer of the sheet.

In an embodiment of the invention, the elongate tubular article is heated to 40 to 240° C. More specifically, the elongate tubular article may be heated to 60 to 200° C., for example, 75 to 180° C., 60-100° C., or 160 to 200° C., depending on the type of adhesive used as the second layer.

In a further embodiment of the invention, there is no additional heating step between steps (c) and (e).

In a further embodiment of the invention, the epoxy is a fusion bonded epoxy powder or a liquid epoxy.

In a further embodiment of the invention, the wrap-around sheet is wound around the elongate metallic tubular article in such a manner that the axis in which the sheet was prestretched generally aligns with the circumference of the elongate metallic tubular article.

In a further embodiment of the invention, the wrap-around sheet is wound around the elongate metallic tubular article in a manner such that the overlapping portion overlaps the two end portions of the sheet.

In a further embodiment of the invention, the wrap-around sheet has a closure strip comprising a high temperature, high shear adhesive tape, or an overlap end being bare of second layer, said closure strip capable of fastening together the end portions of the wrap-around sheet or the end portions are fuse-welded together by application of heat and pressure.

In a further embodiment of the invention, the sheet is wound around the elongate metallic tubular article using an auto-wrapping machine. More specifically, the auto-wrapping machine may contain at least one roller that presses the sheet against the elongate metallic tubular article while the tape is being wound around the elongate metallic tubular article.

### BRIEF DESCRIPTION OF THE FIGURES

Preferred embodiments of the invention will now be described, by way of example to the accompanying drawings, in which:

FIG. 1 is a schematic depicting a cross section of a prior art pipe weld section.

FIG. 2 is a schematic depicting a cross section of a pipe weld section wrapped with a covering of the present invention.

FIG. 3 is a schematic depicting a tape of the present invention being applied onto a pipe.

FIG. 4 is a schematic depicting an axial cross section of a pipe weld section applied with a sheet of the present invention.

FIG. 5 is an illustration depicting a pipe wrapped with a tape of the present invention.

FIG. 6a is an illustration of a tape of the present invention, wound on a reel. FIG. 6b is an illustration of a tape of the present invention, wound on a cardboard core to form a roll.

FIG. 7 is an illustration of a tape of the present invention.

FIG. 8 is an illustration of a sheet of the present invention.

FIG. 9 is a schematic depicting a cross section of a pipe weld section wrapped with a covering of the present invention.

FIG. 10 is an illustration of a sheet of the present invention.

FIG. 11 is an illustration of a tape of the present invention.

### DETAILED DESCRIPTION

The present invention provides a laminated covering comprising: a) a first layer comprising a crosslinked polymeric material which forms an outer lamina of the covering; and b) an second layer which forms an inner lamina of the covering. In a preferred embodiment, the first layer is a heat shrinkable layer comprising a crosslinked polyolefin material. The second layer functions as a “tie layer” between the crosslinked outer (first) layer and the pipe joint substrate. The second layer may be an adhesive layer in the classic sense, a non-crosslinked polyolefin, or a polyamide based layer.

The laminated heat shrinkable coverings according to the invention can be manufactured in forms such as tapes and sheets which may be suitable for protective or insulative coverings for pipe weld joints, electrical cable splices, and the like.

As compared with the prior art, the outer layer of the laminated material has an excellent hot strength, i.e. an increased mechanical resistance, high tensions and high pressures at elevated temperatures, while the inner layer provides sufficiently low melt index/viscosity amd adhesion characteristics. Application of the laminated material is also more effective, consistent, cheaper and quicker.

In particular, the excellent hot strength, i.e. increased resistance to high temperatures, high tensions and high pressures, is a result of the use of a crosslinked polymeric material for the first layer. This renders the covering resistant to melting on application despite the high pipe temperatures needed for the tape to bond to the metallic substrate or the epoxy coating. It additionally renders the covering resistant to tearing during application despite the tension and pressure that are applied by the wrapping machine to ensure the covering conforms to the pipe weld. Furthermore, when the first layer is prestretched, less tension needs to be applied to the covering during application to ensure the covering conforms to the pipe weld since the prestretched layer shrinks upon contact with the heated pipe.

In embodiments using a low viscosity adhesive as the second layer, the adhesive layer provides a sufficiently low melt index/viscosity since the adhesive can easily flow out to fill in the crevices and non-uniformity on the joint surface. Its chemistry can also be tailored to obtain an effective bond to the epoxy and the adjacent mainline coating

Additionally, application of the laminated material is cheaper and quicker due to the use of the second layer. As a result, the pipe only needs to be preheated to 40° C.-200° C. (preferably 60° C.-180° C.) depending on the type of adhesive used as the second layer. For example, perheating of 160-200° C. may be sufficient rather than 220° C.-250° C., when polypropylene systems are used, or for example 80° C.-140° C. (preferably 100° C.-120° C.), when polyethylene systems are used. Some polyamide based systems can even bond at 40-100° C. preheats. This lower temperature saves time and expense, and prevents potential heat damage to the tape.

As compared with the prior art shrink sleeves, the laminated material can be used reliably and successfully with an auto-wrapping machine, as the leading edge will not curl up and away from the pipe weld joint. This is a result of prestretching the sleeve to 0-10% of its original, fully recovered length, as compared with the typical 30%-200% prestretch used in the prior art shrink sleeves. The crosslinked polymeric material used in the first layer can be any polymeric material, but is typically a polyolefin such as polypropylene, polyethylene, a copolymer of propylene and an olefin other than propylene, or a copolymer of ethylene and an olefin other than ethylene. For example, the polymeric material can be a copolymer of propylene and ethylene. The polymeric material can also be a combination or blend of polyolefins if desired, such as a blend of polypropylene and polyethylene. In certain embodiments, the polymeric material is a high density polypropylene, a high density polyethylene, a medium density polyethylene, a linear medium density polyethylene, a low density polyethylene, a linear low density polyethylene, or a combination of any two or more of the above.

In all cases, at least a portion of the polymeric material is cross-linked. The cross-linking can be a light amount of cross-linking, for example 10-35%, an intermediate amount of cross-linking, for example, 35-65%, or a high amount of cross-linking, for example, 65-99%. The cross-linking can be induced by chemical means or by radiation. For example, cross-linking can be induced through the mixing polyolefin resin with a crosslinking reagent and a catalyst during extrusion followed by a post-extrusion curing. Alternatively, cross-linking can be induced through exposure to a radiation source, such as an electron beam, gamma-radiation, or UV light.

Optionally, the laminated material may having a leading edge, for example, of the first 1-6 inches, with a lower degree of stretch, for example, 0-2%, as compared with the rest of the tape. Having a lower degree of stretch at the leading edge of the laminated material will help to further prevent the leading edge of the laminated material from curling up and away from the pipe weld joint on application, and also enhance fusion welding of the overlap.

The crosslinked polymeric material used in the first layer can also be modified with one or more reactive functional groups. For example, the first layer can be modified with vinyl acetate, vinyl alcohol, alkyl acrylates, or a higher olefin, such as butane, hexane or octene. It can also comprise an elastomer, such as an ethylene-propylene diene elastomer, a crystalline propylene-ethylene elastomer, or a thermoplastic polyolefin elastomer.

The crosslinked polymeric material may also comprise an additive, such as cross-linking promoters, compatibilisers, modifiers, pigments, antioxidant stabilizers, heat stabilizers, ultraviolet (UV) stabilizers, fillers, flame retardants, and process aids. Compatibilizers may be any compound that improve dispersion and adhesion of two otherwise incompatible polymers. Some examples of compatibilizers include ethylene-propylene copolymers; ethylene-propylene diene elastomers; crystalline propylene-ethylene elastomers; thermoplastic polyolefin elastomers; metallocene polyolefins; copolymers of ethylene with vinyl acetate, vinyl alcohol, and/or alkyl acrylates; polybutenes; hydrogenated and non-hydrogenated polybutadienes; butyl rubber; polyolefins modified with reactive functional groups selected from the group comprising silanes, alcohols, amines, acrylic acids, methacrylic acids, acrylates, methacrylates, glycidyl methacrylates, and anhydrides; polyolefin ionomers; polyolefin nanocomposites; block copolymers selected from the group comprising styrene-butadiene, styrene-butadiene-styrene, styrene-ethylene/propylene and styrene-ethylene/butylene-styrene; and thermoplastic elastomers comprising polypropylene blended with an elastomer.

The second layer may comprise an adhesive layer, or it may comprise a non-crosslinked tie-layer. The non-crosslinked tie-layer is typically a polyolefin such as polypropylene, polyethylene, a copolymer of propylene and an olefin other than propylene, or a copolymer of ethylene and an olefin other than ethylene. For example, the non-crosslinked polyolefin can be a copolymer of propylene and ethylene. The non-crosslinked polyolefin can also be a combination or blend of polyolefins if desired, such as a blend of polypropylene and polyethylene. In certain embodiments, the non-crosslinked polyolefin is a high density polypropylene, a high density polyethylene, a medium density polyethylene, a linear medium density polyethylene, a low density polyethylene, a linear low density polyethylene, or a combination of any two or more of the above. In some embodiments, the second layer maybe a polyamide adhesive or blend of polyamide with other copolymers and resins.

The crosslinked polymeric layer may be either pre-stretched or non-stretched. While it is not necessary to pre-stretch the crosslinked polymeric layer, pre-stretching by about 1-10% of the layer's original, fully recovered length can facilitate conformance and reduce the amount of tension that must be applied to the laminated material by the auto-wrapping machine. A pre-stretch of 1-10% is particularly useful to facilitate conformance, especially in the area between the cutback and the coating, for pipes with thicker mainline coatings of about 6-10 mm.

Optionally, the laminated material may having a leading edge, for example, the first 1-6 inches, with a lower amount of pre-stretch, for example, about 0-2%, as compared with the rest of the tape, to further prevent the leading edge of the laminated material from curling up and away from the pipe weld joint on application.

Pre-stretching may be induced by deliberate, controlled stretching of the crosslinked sheet, and/or it may be a result of longitudinal orientation imparted during draw-down/stretching during sheet extrusion. The pre-stretching allows for conformance as the covering is applied to the hot pipe. Preferably, the pre-stretching is by 1-10%, for example, about 3-5% of the original, fully recovered length, where percent stretch is measured as:

Percent Stretch=[Stretched Length−Fully Recovered Length]÷Fully Recovered Length×100%

Where the crosslinked polymeric layer is non-stretched, no deliberate stretching is imparted after crosslinking. The layer may, however, have residual longitudinal orientation remaining from extrusion, which typically ranges from 0-5%. When a non-stretched crosslinked polymeric layer is used, some or all of the conformance is obtained by tension applied by the auto-wrapping machine.

In certain embodiments, the laminated covering also has an intermediate layer, between the first layer and the second layer. The intermediate layer is a functional layer, with at least one property superior to said crosslinked polymeric material. The intermediate layer may have increased high temperature penetration resistance, softening point, impact resistance, long-term thermal stability, tensile strength, toughness, stiffness, thermal insulation, electrical conductivity or static dissipation, or impermeability to gases and moisture, as compared to the outer, crosslinked polymeric layer.

Typically, the intermediate layer is also a polyolefin material. It may be crosslinked, like the crosslinked polymeric layer, or it may be partially crosslinked or non-crosslinked. Ideally, the intermediate layer is made with a polymer that is naturally compatible with the polymer of the crosslinked polymeric (first) layer, and of the adhesive layer, however, it may also contain compatibilizers to aid in this respect. In a preferred embodiment, the intermediate layer is made of the same polymer as the first layer. In certain applications, the intermediate layer may be a polyamide adhesive or blend of polyamide with other copolymers and resins.

The intermediate layer may also be pre-stretched, similarly to the first layer.

In order to have the property superior to the crosslinked polymeric layer, the intermediate layer may comprise a filler, a nanocomposite, an engineering thermoplastic, a barrier polymer, a thermally insulating polymer, or an electrically conductive polymer. The filler may be clay, mica, talc, silica, wollastonite, wood, glass fibres, carbon or aramid fibers, other composite fibres, metal oxides, aerogels, or conductive fillers, for example, carbon black or metallic powder. Conductive fillers provide the property of allowing an impressed cathodic current to flow through the coating to prevent the pipe from rusting. The nanocomposite may be comprised of a polyolefin and an exfoliated clay additive. Thermoplastics that may be used include nylons, polyesters, and polyurethanes, for example, polypropylene blended with ethylene propylene. Thermally insulating polymers that may be used include low conductivity insulating fillers, such as hollow glass, ceramic, polymer microspheres, and aerogels. Electrically conductive polymers that may be used include intrinsically conductive polymers such as polyaniline, or electrically conductive fillers such as carbon black or a metal powder, or both.

Like the first layer, the intermediate layer may also comprise an additive such as a cross-linking promoter (in the case of a cross-linked intermediate layer), compatibilizers, modifiers, pigments, antioxidant stabilizers, heat stabilizers, UV stabilizers, fillers, flame retardants, or process aids.

The laminated covering can be in the form of a tape, or a sheet. In certain preferable embodiments, the covering is in the form of a tape having a width of between 2 and 24 inches, preferably 4-16 inches, and a total thickness (of the 2-3 layers) between 0.1 to 4 millimeters, preferably 0.5-2 millimeters.

The laminated covering can also be in the form of a wrap-around sheet, with a width slightly longer than the cut-back region, and a length slightly longer than the diameter, of the pipe to be coated. In certain embodiments, this means a width between 2-60 inches, preferably between 6-36 inches. In preferable embodiments, the laminated covering has a thickness between 0.1 to 6 millimeters, preferably between 0.5 to 3 millimeters.

The sheet may also have a closure strip, for fastening together the end portions of the sheet when it is wrapped around a pipe. The closure strip may be mechanical, for example, having a gripping portion for gripping to the overlapping sheet, or it may be chemical, for example, a high temperature, high shear adhesive tape.

Alternatively, the end portions of the wrap-around sheet may be fastened together by fusion-welding, wherein the overlapping end portions are fused together by the application of heat and pressure. In such cases, it is sometimes advantageous to have an overlapping end portion (a closure strip) that is devoid of second layer, so that the first layer on the closure strip area can be bonded to the first layer of the opposing length of the wrap-around sheet.

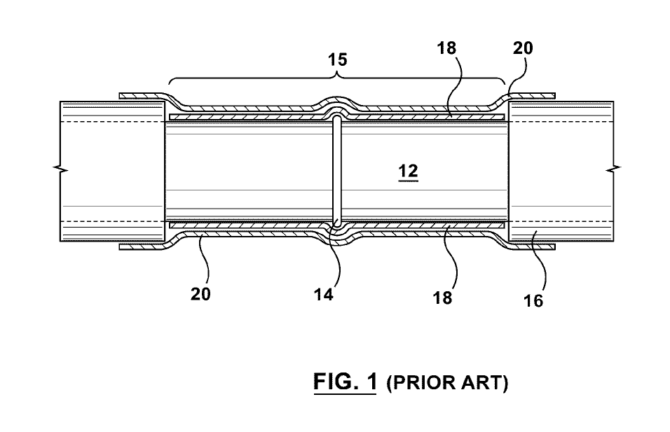

FIG. 1 shows a schematic, cross-sectional view of a prior art pipe joint, covered with a prior art pipe joint covering. Two adjacent pieces of pipe 12 have facing free ends welded at weld 14. Pipe 12 has a mainline coating 16, typically a polyolefin such as polyethylene. The pipe joint cutback region 15 is absent of any mainline coating. Pipe 12 is typically coated with fusion bonded epoxy layer 18, then covered with a polyolefin layer 20. The polyolefin layer 20 may be applied as a tape, using an auto-winder, which applies both tension and heat while winding the tape around the pipe, and bonds to the fusion bonded epoxy layer 18 and the mainline coating 16. Alternatively, the polyolefin layer 20 may be applied as a sheet, and wrapped around the pipe, again, using both tension and heat to bond the polyolefin layer 20 to both the fusion bonded epoxy layer 18 and the mainline coating 16.

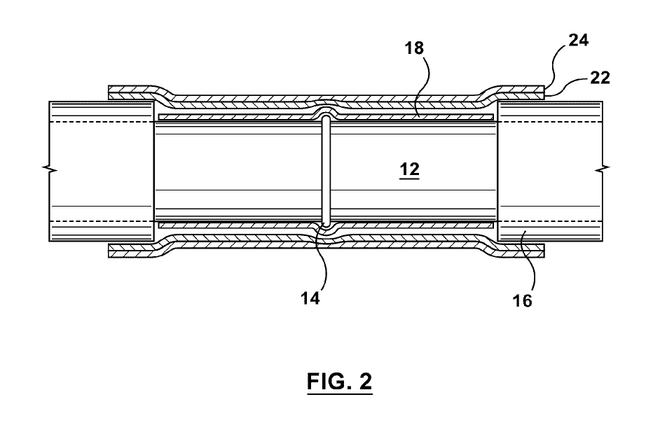

FIG. 2 shows a schematic, longitudinal cross-sectional view of the pipe joint covering of the present invention, coating or covering a pipe joint. Pipe joint comprises pipe 12, weld 14, mainline coating 16 and fusion bonded epoxy layer 18, identical to as previously described in FIG. 1. Pipe 12 is covered with the covering of the present invention, comprising second layer 22 and cross-linked polymer layer 24. The covering of the present invention can be applied as a tape, using an auto-winder, which applies tension, and optionally, heat, while winding the tape around the pipe, and bonds to the fusion bonded epoxy layer 18 and the mainline coating 16. One advantage of the covering of the present invention is that higher heat can be utilized, if desired, since the cross-linking of the cross-linked polymer layer 24 provides increased heat stability. In certain, preferable, embodiments, where the cross-linked polymer layer 24 is also pre-stretched as previously described, a lower amount of tension is required to wind the tape to the pipe and still provide enough hoop stress to obtain the desirable, tight, conformity to the pipe joint. This is because the hoop stress is created not only from the tension provided by the auto-winder, but also from the shrinking of the tape as it contacts the hot surface of the epoxy layer 18, or as it is heated by the auto-wrapping device.

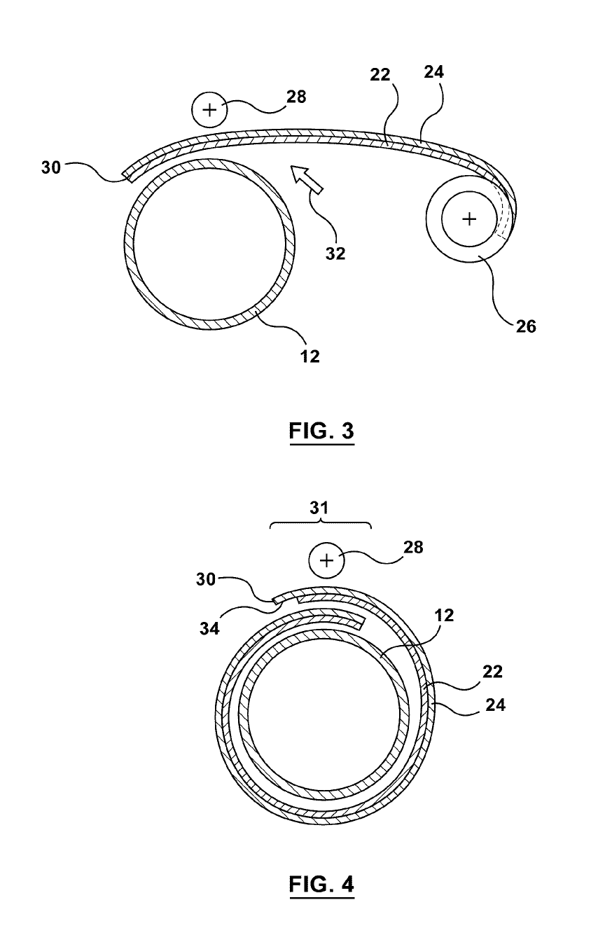

FIG. 3 shows a schematic view of an axial cross-section of a tape of the present invention being wrapped around a pipe joint. Shown is pipe 12, proximal to a joint weld (not shown) and having a coating of epoxy primer (not shown). A tape of the present invention comprises an end 30, a second layer 22 and a crosslinked polymer layer 24. The end 30 of the tape is placed on the hot pipe and bonds to the epoxy coating preapplied to steel. Tape is unwound from roll 26 and wrapped around the pipe 12. Roller 28 applies pressure to the tape to aid in bonding to the epoxy coating on the pipe 12. In addition, a heat source, such as an infra red heater (not shown) or a flame 32 applies heat directly to the second layer 22 and the epoxy coating on the pipe 12 at and proximal of the point of contact between the two. This helps further activate the second layer 22 and aids in bonding the tape to the epoxy coating on the pipe 12.

FIG. 4 shows a schematic view of an axial cross-section of a sheet of the present invention being wrapped around a pipe joint. Shown is pipe 12, proximal to a joint weld (not shown) and having a coating of epoxy (not shown). A sheet of the present invention comprises an end 30, a second layer 22 and a crosslinked polymer layer 24. The end 30 of the sheet has an adhesive-free section 34, where the adhesive lamina is absent. As shown, a roller 28 aids in bonding the sheet to itself in an overlap region 31.

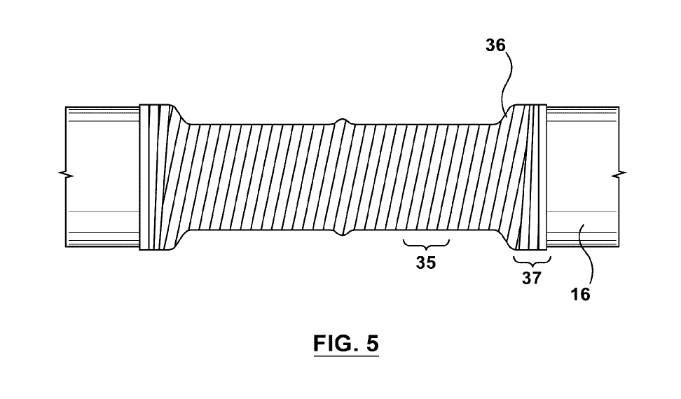

FIG. 5 is a schematic view of a longitudinal section of a pipe joint on which a tape of the present invention has been wrapped. Shown is mainline coating 16 and tape 36. As shown, the tape 36 has been wrapped tightly around the pipe joint, and there is no exposed area of pipe. Only the tape 36 of the present invention and the mainline coating 16 are exposed to the elements. Note that certain sections 37 of the tape 36 are bonded to the mainline coating 16, whereas other sections 35 of the tape 36 are bonded to the epoxy coating on the pipe in the cutback region. The tape 36 was wrapped around the pipe using a standard auto-wrapping machine as typically used in the industry, (for example, Pipeline Induction Heat Ltd's (PIH) PP/PE Automated Tape Wrap machine, as previously described) but required less tension (due to the use of a pre-stretched cross-linked polymer layer) and less heat (due to the use of adhesive requiring a lower heat to activate than polypropylene) than would have been necessary for a traditional polypropylene-based prior art tape.

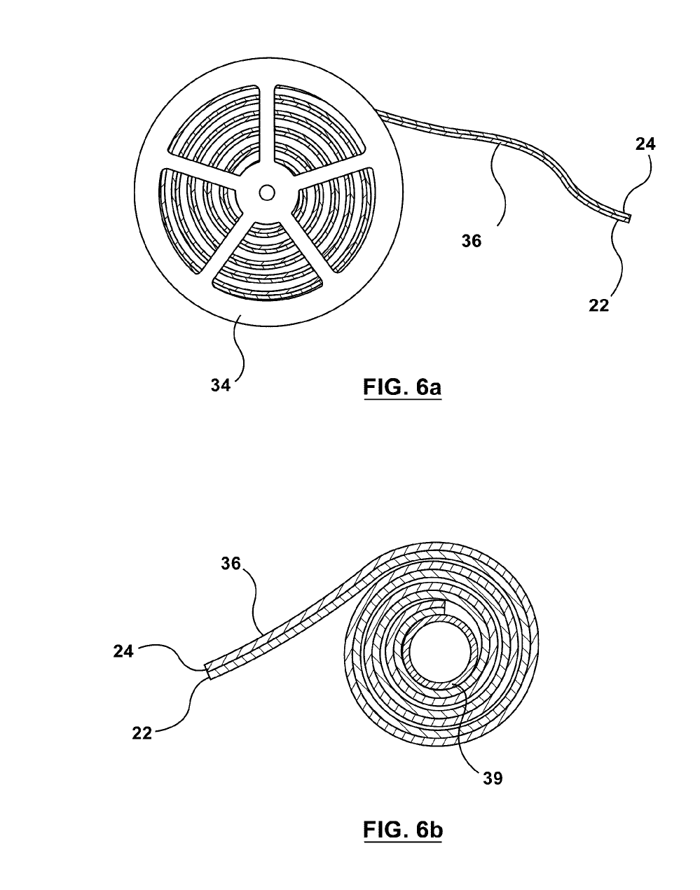

FIG. 6a shows a reel 38 of the tape 36 of the present invention. Reels such as this one can be used with a standard auto-wrapping machine for the installation of the tape 36. FIG. 6b shows the tape 36 wound on a cardboard core 39 to form a roll.

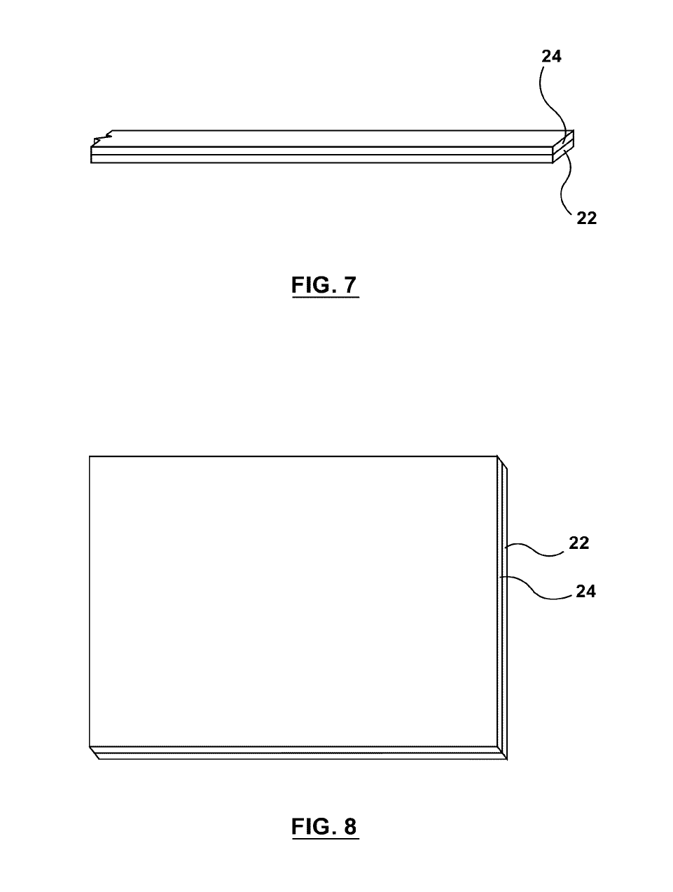

FIG. 7 shows a tape 36 of the present invention, including a cross-linked, pre-stretched polymer layer 24 of polypropylene, and a second layer 22. Similarly, FIG. 8 shows a sheet of the present invention, including a cross-linked, pre-stretched polymer layer 24 of polypropylene, and a second layer 22.

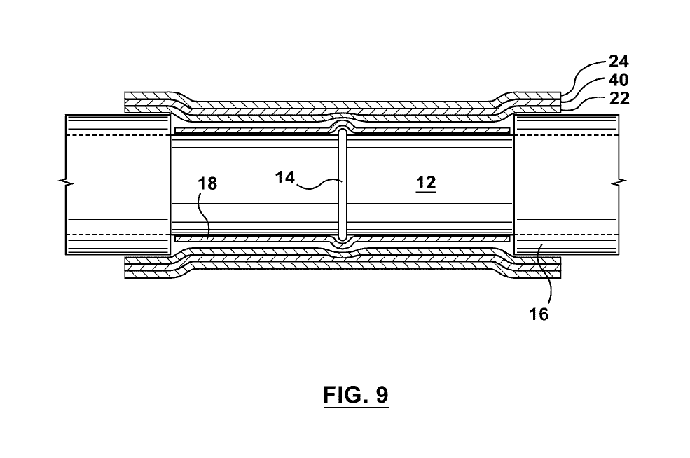

FIG. 9 shows a schematic, longitudinal cross-sectional view of another embodiment of the pipe joint covering of the present invention, coating or covering a pipe joint. Notably, the covering includes an intermediate functional layer 40. Pipe joint comprises pipe 12, weld 14, mainline coating 16 and fusion bonded epoxy layer 18, and covering includes second layer 22 and cross-linked polymer layer 24, as described in FIG. 2. However, covering also includes intermediate functional layer 40, between cross-linked polymer layer 24 and second layer 22. In this embodiment, cross-linked polymer layer 24 is a pre-stretched (to 110%) cross-linked polyolefin. The intermediate layer 40 comprises a crosslinked or non-crosslinked, non-stretched or pre-stretched, polyolefin material containing a filler to improve specific properties of the covering. The filler may be clay, mica, talc, silica, wollastonite, wood, glass fibres, carbon or aramid fibers, other composite fibres, metal oxides, aerogels, or conductive fillers, for example, carbon black or metallic powder. Conductive fillers provide the property of allowing an impressed cathodic current to flow through the coating to prevent the pipe from rusting. The covering of the present invention can be applied as a tape, using an auto-winder, which applies tension, and optionally, heat, while winding the tape around the pipe, and bonds to the fusion bonded epoxy layer 18 and the mainline coating 16.

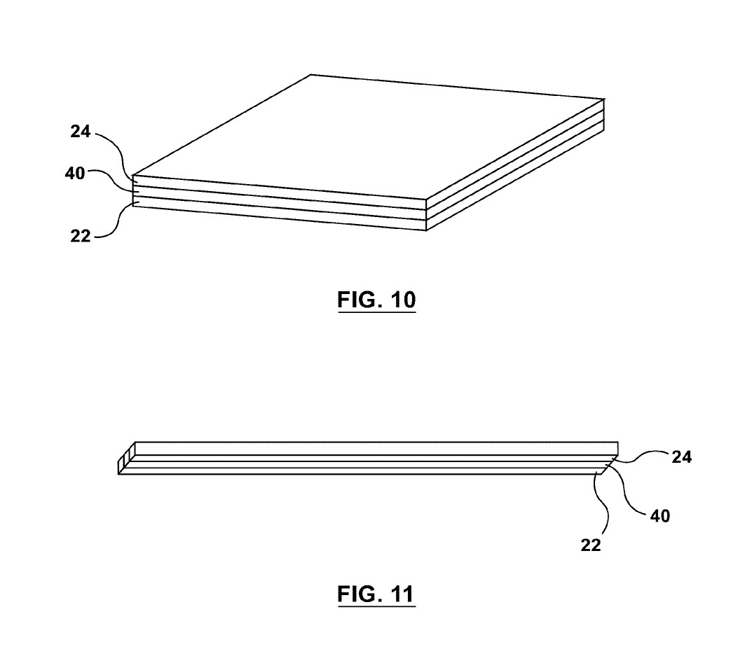

FIG. 10 shows a covering of the present invention in the form of a sheet, including a cross-linked, pre-stretched polymer layer 24 of polyolefin, a second layer 22, and an intermediate layer 40. Similarly, FIG. 11 shows a sheet of the present invention, including a cross-linked, pre-stretched polymer layer 24 of polyolefin, an intermediate layer 40, and a second layer 22.

To coat a pipe cutback region with a tape of the present invention, the exposed pipe in the cutback region is surface treated and cleaned such that it is free of visible rust, and heated in a first heating step. A coating of epoxy is applied, either in powder form (fusion bonded epoxy) or in liquid form. In the case of fusion bonded epoxy coating, the first heating step is to 220-250 C; after which the fusion bonded epoxy is applied. In the case of liquid coating, the first heating step requires heating to 40-60° C., or to at least 10° C. above the dew point, to dry the pipe. Then the liquid epoxy is applied. The pipe is further heated in a second heating step, to 100-200° C., preferably to 120-180° C. to cure the epoxy. An auto-wrapping machine, loaded with a tape of the present invention, is placed on the pipe joint and activated, so that it wraps the tape around the pipe. Preferably, the tape is wound spirally around the pipe with an overlap of between about 5 to 55% of the width of the tape. Tension is applied to the tape by the auto-wrapping machine as the tape is applied. Optionally, the auto-wrapping machine also provides heat to the tape, although in many instances the pipe is still hot enough (from the heating before the epoxy application) to activate the adhesive on the tape, and to shrink the pre-stretched tape, upon contact with the pipe. Optionally and preferably, the auto-wrapping machine comprises a roller which presses the tape against the pipe while wrapping. Tape is wrapped in an overlapping fashion around the diameter of the pipe, and extends beyond the cutback region and bonds to the mainline coating to both sides of the cutback. The tape can be wound multiple times, providing multiple layers of tape, if required to provide the desired thickness of coating.

To coat a pipe cutback region with a sheet of the present invention, the exposed pipe in the cutback region is surface treated and cleaned such that it is free of visible rust, and heated in a first heating step. A coating of epoxy is applied, either in powder form (fusion bonded epoxy) or in liquid form. In the case of fusion bonded epoxy coating, heating to 220-250° C. is required; in the case of liquid coating, heating to 100-200° C. is required, preferably to 120-180° C. The sheet is then wrapped around the cutback region of the pipe and is longer than the cutback region so that it extends to and contacts the mainline coating on both sides of the cutback region. The sheet is also slightly longer than the diameter of the mainline coating surrounding the pipe, such that an overlap region is created when the sheet is wrapped around the pipe. The sheet is bonded to itself using an adhesive, or affixed to itself using mechanical means, at or surrounding the overlap region. Alternatively, the sheet may comprise a closure strip which fastens together the end portions of the sheet. The sheet is heated by the hot pipe and shrinks to conform tightly to the geometry of the cutback region and surrounding mainline coating. In certain embodiments, the sheet can be wound around the pipe using an auto-wrapping machine.

The laminated material, regardless of whether it is a tape or a sheet, is preferably wrapped tightly around the pipe weld joint. The tension applied to the tape by the auto-wrapping machine upon application, and optionally the small prestretch, expels air upon the tape making contact with the substrate. The tension, and optionally the small prestretch, also imparts the hoop stress necessary to sustain the sealing capacity of the laminated covering.

### Example 1

### Testing of Properties of Prior Art Polypropylene Tape v. Crosslinked Single Ply Tape

The compressive stress and tensile strength of a prior art single layer 1.0 mm thick non-crosslinked polypropylene tape was measured. Such tape has a melting point of 165° C., and is typically wrapped around a pipe joint using conventional methodology at a temperature of 180° C.-240° C. Therefore, the testing was performed at 200° C., close to the lower end of the temperature range at which such a tape would typically be wrapped around a pipe joint.

Compressive properties were measured as % reduction in thickness (i.e. % penetration of the tape) when a static load of 0.65 N/cm² was applied onto the tape for 1 hour at 200° C. The result was that 100% of the thickness of the tape was lost.

Tensile strength was measured at 200° C., and yielded a tensile strength of 0.2N/cm², and a break at only 2% elongation.

Similar tests were done on a similar tape, but which had been crosslinked at a level of about 50% crosslinking. Approximately 12% of the tape thickness was lost, and the tensile strength was measured to be 8.5 N/cm² at 100% elongation.

This shows that the non-cross-linked tape softened excessively and had undergone almost complete plastic deformation at 200° C., while the crosslinked tape partially maintained its structure, shape and thickness. The non-crosslinked tape was found to have almost zero tensile strength, and 2% elongation illustrated that it had basically melted away, whereas the crosslinked tape essentially maintained its structure, shape and tensile properties at 200° C.

### Example 2

### Testing of Properties of Prior Art Polyethylene Tape v. Crosslinked Single Ply Tape

The compressive stress and tensile strength of a prior art single layer 1.0 mm thick non-crosslinked high density polyethylene tape was measured. Such tape has a melting point of about 130° C., and is typically wrapped around a pipe joint using conventional methodology at a temperature of 120° C.-150° C. Testing was therefore performed at 150° C., the higher of the temperature range at which such a tape would typically be wrapped around a pipe joint.

Compressive properties were measured as % reduction in thickness (i.e. % penetration of the tape) when a static load of 0.65 N/cm² was applied onto the tape for 1 hour at 150° C. The result was that approximately 100% of the thickness of the tape was lost.

Tensile strength was measured at 100% strain, at 150° C., and yielded a tensile strength of 1.1N/cm² at 3% elongation.

Similar tests were done on a similar tape, but which had been crosslinked at a level of about 70% crosslinking. Approximately 9.5% of the tape thickness was lost, and the tensile strength was measured to be 193 N/cm² psi at 100% elongation.

This shows that the non-cross-linked tape softened excessively and had undergone almost complete plastic deformation at 150° C., while the crosslinked tape maintained its structure, shape and thickness. The non-crosslinked tape was found to have almost zero tensile strength, and 3% elongation illustrated that it had basically melted away, whereas the crosslinked tape essentially maintained its structure, shape and tensile properties at 150° C.

### Example 3

### Manufacturing of a Non-Stretched Tape

A crosslinked polypropylene sheet was manufactured using the materials and process described in U.S. Pat. No. 6,794,453, incorporated herein in its entirety. The following formulation was used, measured in weight %:

| | |
|---|---|
| Profax 7823 Polypropylene (LyondellBasell) | 68% |
| Silane Grafted High Density Polyethylene | 28% |
| (DSG-Canusa) | |
| Dibutyl Tin Dilaurate | 2% |
| Irganox 1010 antioxidant (BASF) | 2% |

The sheet was extruded at a thickness of 0.7 mm in a width of 700 mm, and reeled. The sheet was then crosslinked by conditioning the reeled sheet at a temperature of 88° C. and a relative humitidy of 95% for 120 hours. The degree crosslink level of the sheet was measured to have a gel fraction of 37%, a hot tensile strength at 200° C. at 100% elongation of 12 psi, and a longitudinal orientation of 1.5%.

An adhesive layer of a polypropylene copolymer with maleic anhydride (Orevac 18275 (Arkema)) was laminated onto the crosslinked sheet at a thickness of 0.5 mm. The sheet was then cut into tape having dimensions of a total thickness of 1.2 mm (crosslinked layer of 0.7 mm and an adhesive layer of 0.5 mm), a width of 100 mm, and a length of 50 m.

### Example 4

### Coating of a Pipe

A steel 16″ pipe with a 3 mm thick polypropylene coating was prepared with a 300 mm cutback. The edges of the polypropylene coatings adjacent to the steel cutback were grinded to expose fresh surface, and beveled to an angle of 30 degrees. The steel was grit blasted to SA 2½ finish. The joint was prewarmed to 50° C. with induction heating, and the steel was then coated with liquid epoxy (P-Primer Epoxy, Canusa-CPS) to a thickness of 200 microns. The joint was then heated by induction until the steel reached a temperature of 185° C. and the adjacent coating 140° C. A roll of tape as described in Example 3 was mounted onto an auto tape wrapping machine and the tape was wound under tension onto the pipe joint at a slight angle to obtain 55% overlap onto itself. A flame was mounted on the tape wrapping machine so that it was directed at the adhesive just prior to making contact with the substrate (i.e. the cutback and coating). A rubber coated roller followed on top of the tape after contact was made with the substrate, to apply pressure onto the tape to promote conformance and adhesion. At the end of the wrapping, the end of the tape was secured by applying a closure strip with a high shear adhesive.

The properties of the tape coating were tested, and the characteristics of the wrap were summarized in Table 1:

| PROPERTY | UNIT | REQUIREMENTS | METHOD | RESULTS |
|---|---|---|---|---|
| Peel Strength @ 100° C. | N/cm | >40 | NF A 49-711 | 55 |
| Impact Strength | J/mm | >10 J/mm | NF A 49-711 | PASS |
| Holiday Detection | N/A | >10 KV/mm | NF A 49-711 | PASS |
| Thickness (double layer) | mm | >2 mm | NF A 49-711 | 2.2 |
| Low Temperature Flexibilty | ° C. | <−5 | 1″ Mandrel | Pass at −6, |
| | | | | no cracking |
| Cathodic Disbondment @ | mm radius | <5 mm | CSA | 2 |
| 95° C., 48 hrs | | | | |

### Example 5

### Manufacturing of a Pre-Stretched Tape

A crosslinked polypropylene sheet was manufactured using the materials and process described in U.S. Pat. No. 6,794,453, incorporated herein in its entirety. The following formulation was used, measured in weight:

| | |
|---|---|
| Profax 7823 Polypropylene (LyondellBasell) | 70 parts |
| Silane Grafted High Density Polyethylene | 28 parts |
| (DSG-Canusa) | |
| Dibutyl Tin Dilaurate | 2 parts |
| Irganox 1010 antioxidant (BASF) | 2 parts |

The sheet was extruded at a thickness of 0.7 mm in a width of 700 mm, and reeled. The sheet was then crosslinked by conditioning the reeled sheet at a temperature of 88° C. and a relative humidity of 95% for 120 hours. The degree crosslink level of the sheet was measured to have a gel fraction of 37%, a hot tensile strength at 200° C. at 100% elongation of 12 psi, and a longitudinal orientation of 1.5%.

After the crosslinked sheet was produced, it was pre-stretched on a longitudinal stretching machine. The sheet was first heated to 155° C. via contact with heating rollers, then a stretch was applied via rolls rotating at different speeds. The speed of the faster stretching roller imparted the stretch. A 3.5% stretch was given to the sheet. This resulted in a longitudinal orientation of 4.0% (although only 3.5% stretch was provided, the residual orientation from the extrusion process partially added to the overall stretch).

The crosslinked sheet, after stretching, had a thickness of 0.6 mm.

An adhesive layer of a polypropylene copolymer with maleic anhydride (Orevac 18275 (Arkema)) was laminated onto the crosslinked sheet at a thickness of 0.5 mm. The sheet was then cut into tape having dimensions of a total thickness of 1.1 mm (crosslinked layer of 0.6 mm and an adhesive layer of 0.5 mm), a width of 100 mm, and a length of 50 m.

### Example 6

### Coating of a Pipe

A steel 16″ pipe with a 3 mm thick polypropylene coating was prepared with a 300 mm cutback. The edges of the polypropylene coatings adjacent to the steel cutback were grinded to expose fresh surface, and beveled to an angle of 30 degrees. The steel was grit blasted to SA 2½ finish. The joint was prewarmed to 50° C. with induction heating, and the steel was then coated with liquid epoxy (P-Primer Epoxy, Canusa-CPS) to a thickness of 200 microns. The joint was then heated by induction until the steel reached a temperature of 185° C. A roll of tape as described in Example 5 was mounted onto an auto tape wrapping machine and the tape was wound under tension onto the pipe joint at a slight angle to obtain 55% overlap onto itself. A flame was mounted on the tape wrapping machine so that it was directed at the adhesive just prior to making contact with the substrate (i.e. the cutback). A rubber coated roller followed on top of the tape after contact was made with the substrate, to apply pressure onto the tape to promote conformance and adhesion. At the end of the wrapping, the end of the tape was secured by applying a closure strip with a high shear adhesive. It was observed that, compared to Example 4, less tension was necessary to apply the tape, since, upon making contact with the hot joint substrate, the tape had a tendency to recover and come into an intimate conformance to the pipe joint profile, as compared to the tape of Example 4.

The properties of the tape coating were tested, and the characteristics of the wrap were identical of that of Example 4 (i.e. Table 1), with the exception that the measured thickness of a double layer was 2.10 mm.

### Example 7

### Manufacturing of a Pre-Stretched Tape Having a Functional Layer

A crosslinked polypropylene sheet was manufactured using the materials and process described in U.S. Pat. No. 6,794,453, incorporated herein in its entirety. The following formulation was used, measured in weight:

| | |
|---|---|
| Profax 7823 Polypropylene (LyondellBasell) | 68 parts |
| Silane Grafted High Density Polyethylene | 28 parts |
| (DSG-Canusa) | |
| Dibutyl Tin Dilaurate | 2 parts |
| Irganox 1010 antioxidant (BASF) | 2 parts |

The sheet was extruded at a thickness of 0.5 mm in a width of 700 mm, and reeled. The sheet was then crosslinked by conditioning the reeled sheet at a temperature of 88° C. and a relative humidity of 95% for 120 hours. The degree crosslink level of the sheet was measured to have a gel fraction of 37%, a hot tensile strength at 200° C. at 100% elongation of 12 psi, and a longitudinal orientation of 1.5%.

After the crosslinked sheet was produced, it was pre-stretched on a longitudinal stretching machine. The sheet was first heated to 155° C. via contact with heating rollers, then a stretch was applied via rolls rotating at different speeds. The speed of the faster stretching roller imparted the stretch. A 4.0% stretch was given to the sheet. This resulted in a longitudinal orientation of 4.75% (although only 4% stretch was provided, the residual orientation from the extrusion process partially added to the overall stretch).

The crosslinked sheet, after stretching, had a thickness of 0.4 mm.

A functional layer, formulated to provide an enhanced thermal insulation, was manufactured having the following composition, by weight percent:

| | |
|---|---|
| Profax 7823 Polypropylene (LyondellBasell) | 20% |
| Sclair 2907 High Density Polyethylene (Nova) | 55% |
| Nordel IP4820 (Dow) | 5% |
| Zeeospheres G600 glass spheres (Zeeospheres | 18% |
| Ceramics LLC) | |
| Irganox 1010 antioxidant (BASF) | 2% |

The functional layer was laminated onto the crosslinked layer at a thickness of 0.3 mm.

An adhesive layer of a polypropylene copolymer with maleic anhydride (Orevac 18275 (Arkema)) was then laminated onto the functional layer at a thickness of 0.5 mm. The sheet was then cut into tape having dimensions of a total thickness of 1.2 mm (crosslinked layer of 0.4 mm, a functional layer of 0.3 mm and an adhesive layer of 0.5 mm), a width of 100 mm, and a length of 50 m.

### Example 8

### Coating of a Pipe

A steel 16″ pipe with a 3 mm thick polypropylene coating was prepared with a 300 mm cutback. The edges of the polypropylene coatings adjacent to the steel cutback were grinded to expose fresh surface, and beveled to an angle of 30 degrees. The steel was grit blasted to SA 2½ finish. The joint was prewarmed to 50° C. with induction heating, and the steel was then coated with liquid epoxy (P-Primer Epoxy, Canusa-CPS) to a thickness of 200 microns. The joint was then heated by induction until the steel reached a temperature of 185° C. A roll of tape as described in Example 7 was mounted onto an auto tape wrapping machine and the tape was wound under tension onto the pipe joint at a slight angle to obtain 55% overlap onto itself. A flame was mounted on the tape wrapping machine so that it was directed at the adhesive just prior to making contact with the substrate (i.e. the cutback). A rubber coated roller followed on top of the tape after contact was made with the substrate, to apply pressure onto the tape to promote conformance and adhesion. At the end of the wrapping, the end of the tape was secured by applying a closure strip with a high shear adhesive. It was observed that, compared to Example 4, less tension was necessary to apply the tape, since, upon making contact with the hot joint substrate, the tape had a tendency to recover and come into an intimate conformance to the pipe joint profile, as compared to the tape of Example 4.

The properties of the tape coating were tested, and the characteristics of the wrap were identical of that of Example 4 (i.e. Table 1).

### Example 9

### Thermal Conductivity Testing

Thermal conductivity testing was carried out on the tape of Examples 7 and 8, to measure the improvement in thermal insulative properties of the tape, as compared to the tape of Examples 3 and 4. The test was carried out on a Fox40 Thermal Conductivity machine using WinTherm 50v3, Version 3.30.07 software. Thermal conductivity of a 1.2 mm thickness of the tape of Examples 3 and 4 was found to be 0.33 W/mK at 30° C., whereas the thermal conductivity of an equivalent thickness of the tape of Examples 7 and 8 was 0.28 W/mK, resulting in a 12% improvement in the thermal insulation property of a tape having the functional intermediate layer.

### Example 10

### Manufacturing of a Pre-Stretched Tape with a Leading Edge with a Lower Degree of Crosslinking

A crosslinked polypropylene sheet is manufactured using the materials and process described in U.S. Pat. No. 7,456,231 B2, Example 1, incorporated herein in its entirety. The following formulation is used, measured in weight:

| | |
|---|---|
| 1. Profax 7823 Polypropylene (LyondellBasell) | 30 parts |
| 2. Finathene CD 4300 (Atofina) | 60 parts |
| 3. Nordel IP 4820P (Dupont) | 10 parts |
| 4. Irganox B225 (Ciba Geigy) mastrebacth | 12 parts |
| 5. Carbon black Masterbatch | 0.5 parts |

The sheet is extruded at a thickness of 0.5 mm in a width of 700 mm, and reeled. The sheet is then crosslinked by electron beam radiation as described in U.S. Pat. No. 7,456,231 B2, Example 1, except that dosage used was 2.5 Mrads due to lower sheet thickness. The objective of this trial was to crosslink the sheet sufficiently for the joint wrapping, but also to have 100 mm end portion of the tape at low crosslink level to facilitate the fusion to secure the end after the roll of tape is wound onto the joint. In this example the product was designated to be for a 300 mm OD pipe and a joint width of 400 mm. This joint would require a roll of 100 mm wide tape of 750 cm length. On full reel of 500 meters, every 750 cm were shielded with a 100 mm×400 mm with a self-adhesive aluminium tape on one side. The aluminium shields the sheet radiation from one side, thus reducing the crosslinking of the shielded 100 mm zone.

The degree crosslink level of all but the first 1000 mm zone of the reeled sheet is measured to have a gel fraction of 55%, a hot tensile strength at 200° C. at 100% elongation of 10 psi, and a longitudinal orientation of 1.5%. The degree crosslink level the first 100 mm zone of the reeled sheet is measured to have a gel fraction of 17%, a hot tensile strength at 200° C. at 100% elongation of 2.3 psi, and a longitudinal orientation of 1.3%.

### Example 11

### Manufacturing of a Pre-Stretched Tape with a Leading Edge with Less Pre-Stretch

A crosslinked polypropylene sheet is manufactured using the materials and process described in U.S. Pat. No. 6,794,453, incorporated herein in its entirety. The following formulation is used, measured in weight:

| | |
|---|---|
| Profax 7823 Polypropylene (LyondellBasell) | 68 parts |
| Silane Grafted High Density Polyethylene | 28 parts |
| (DSG-Canusa) | |
| Dibutyl Tin Dilaurate | 2 parts |
| Irganox 1010 antioxidant (BASF) | 2 parts |

The sheet is extruded at a thickness of 0.5 mm in a width of 700 mm, and reeled. The sheet is then crosslinked by conditioning the reeled sheet at a temperature of 88° C. and a relative humidity of 95% for 120 hours. The degree crosslink level of the reeled sheet is measured to have a gel fraction of 37%, a hot tensile strength at 200° C. at 100% elongation of 12 psi, and a longitudinal orientation of 1.5%.

After the crosslinked sheet is produced, it is pre-stretched on a longitudinal stretching machine. The sheet is first heated to 165° C. via contact with heating rollers, then a stretch is applied via rolls rotating at different speeds. The speed of the faster stretching roller imparted the stretch. A 3.5% stretch was given to the sheet. This resulted in a longitudinal orientation of 4.5% (although only 3.5% stretch was provided, the residual orientation from the extrusion process added to the overall stretch).

The crosslinked sheet, after stretching, had a thickness of 0.6 mm.

It was determined that a roll of 100 mm wide tape width a length of 750 cm would be required to wrap a pipe OD of 300 mm having a joint width of 400 mm. The end portion of the roll was recovered by placing the 100 mm end of tape in to a slit oven for 3 minutes at 200° C., and then placing it a 2-platen press to cool and flatten the tape end zone. This basically removed strech and recovery from the end of the tape. When measured, it showed zero stretch remaining in the recovered end.

### Example 5

### Manufacturing of a Pre-Stretched Tape with Polyamide Adhesive System

A crosslinked polyethylene sheet was manufactured using radiation crosslinked sheet comprised of

| | | |
|---|---|---|
| High density polyethylene (HE-Y449-A HDPE, | 77.5 | parts by weight |
| Nova Chemicals) | | |
| Ethylene Vinyl Acetate (Elvax 670, Dupont) | 20 | parts by weight |
| Irganox 1010 antioxidant (BASF) | 2.0 | parts by weight |
| Carbon black Masterbatch | 0.5 | parts by weight |

The sheet was extruded at a thickness of 0.7 mm in a width of 700 mm, and reeled. The sheet was then crosslinked by electron radiation at 8 Mrads. The degree crosslink level of the sheet was measured to have a gel fraction of 67%, a hot tensile strength at 140° C. at 400% elongation of 6 Kg/cm², and a longitudinal orientation of 1.7%.

After the crosslinked sheet was produced, it was pre-stretched on a longitudinal stretching machine. The sheet was first heated to 125° C. via contact with heating rollers, then a stretch was applied via rolls rotating at different speeds. The speed of the faster stretching roller imparted the stretch. A 3.0% stretch was given to the sheet. This resulted in a longitudinal orientation of 3.8% (although only 3.0% stretch was provided, the residual orientation from the extrusion process partially added to the overall stretch).

The crosslinked sheet, after stretching, had a thickness of 0.6 mm.

An adhesive layer of a polyamide adhesive (Macromelt MM from Henkel Adhesives) was laminated onto the crosslinked sheet at a thickness of 0.5 mm. The sheet was then cut into tape having dimensions of a total thickness of 1.1 mm (crosslinked layer of 0.6 mm and an adhesive layer of 0.5 mm), a width of 100 mm, and a length of 50 m.

### Example 6

### Coating of a Pipe

A 12″ steel with a 2 mm thick polyethylene coating was prepared with a 300 mm cutback. The edges of the polyethyelylene coatings adjacent to the steel cutback were grinded to expose fresh surface, and beveled to an angle of 30 degrees. The steel was grit blasted to SA 2½ finish. The joint steel and the adjacent PE coating was heated to 65° C. with a torch. A roll of tape as described in Example 5 was mounted onto an auto tape wrapping machine and the tape was wound under tension onto the pipe joint at a slight angle to obtain 55% overlap onto itself. A flame was mounted on the tape wrapping machine so that it was directed at the adhesive just prior to making contact with the joint substrate. A rubber coated roller followed on top of the tape after contact was made with the substrate, to apply pressure onto the tape to promote conformance and adhesion. At the end of the wrapping, the end of the tape was secured by applying a closure strip with a high shear adhesive.

The properties of the tape coating were tested as follows:

| | | | |
|---|---|---|---|
| Peel Strength (EN 12068) | @23° C. | >130 | N/cm |
| | @60° C. | 18 | N/cm |
| Cathodic Disbondment | @23° C., 28 days | 2.0 | mm |
| (EN 12068) | @60° C., 48 hr | 2.5 | mm |

1. A laminated covering for use with an auto-wrapping machine comprising:
a) a first layer comprising a crosslinked polymeric material which forms an outer lamina of the covering; and
b) a second layer which forms an inner lamina of the covering.

2. The laminated covering according to claim 1, wherein the crosslinked polymeric material is a crosslinked polyolefin.

3. The laminated covering according to claim 2 wherein the crosslinked polyolefin is a crosslinked polyethylene.

4. The laminated covering according to claim 2 wherein the crosslinked polyolefin is a crosslinked polypropylene.

5. The laminated covering according to claim 1, wherein a leading edge of about 1-6 inches has a lower degree of crosslinking as compared with the rest of the laminated covering.

6. The laminated covering according to claim 1, wherein the first layer is a heat shrinkable layer.

7. The laminated covering according to claim 6, wherein the crosslinked polymeric material is prestretched by under 20% of its original, fully recovered length.

8. The laminated covering according to claim 7, wherein the crosslinked polymeric material is prestretched by 1 to 10% of its original, fully recovered length.

9. The laminated covering according to claim 8, wherein the crosslinked polymeric material is prestretched by 5% of its original, fully recovered length.

10. The laminated covering according to claim 1, wherein the leading edge of about 1-6 inches is prestretched by up to or less than 2% of its original, fully recovered length.

11. The laminated covering according to claim 1, wherein the polymeric material is epoxy-free.

12. The laminated covering according to claim 1, wherein the second layer is an adhesive layer.

13. The laminated covering according to claim 12 wherein the adhesive layer comprises a polyamide.

14. The laminated covering according to claim 13 wherein the adhesive layer comprises a polyamide adhesive or a blend of polyamide with other copolymers and/or resins.

15. The laminated covering according to claim 1, wherein the second layer is a non-crosslinked tie layer comprising a noncrosslinked polymeric material.

16. The laminated covering according to claim 15 wherein the noncrosslinked polymeric material comprises a noncrosslinked polyethylene or its copolymer.

17. The laminated covering according to claim 15 wherein the noncrosslinked polymeric material comprises a noncrosslinked polypropylene or its copolymer.

18. The laminated covering according to claim 1, wherein the first layer comprises polypropylene, polyethylene, and an antioxidant and is crosslinked using radiation or chemical methods.

19. The laminated covering according to claim 1, wherein the second layer comprises a polypropylene copolymer with maleic anhydride.

20. The laminated covering according to claim 1, comprising an additional functional layer which forms an intermediate lamina of the covering, said functional layer having at least one property superior to said crosslinked polymeric material, said at least one property selected from a group consisting of high temperature penetration resistance, softening point, impact resistance, long-term thermal stability, tensile strength, toughness, stiffness, thermal insulation, electrical conductivity or static dissipation, and impermeability to gases and moisture.

21-83. (canceled)
